(19) United States
(12) Patent Application Publication
(10) Pub. No.: US 2025/0277408 A1
(43) Pub. Date: Sep. 4, 2025

(54) Extended Platform Apparatus for Use with a Ladder

(71) Applicant: John J. Goneau, Beverly, MA (US)

(72) Inventor: John J. Goneau, Beverly, MA (US)

(21) Appl. No.: 19/213,590

(22) Filed: May 20, 2025

Related U.S. Application Data
(63) Continuation-in-part of application No. 29/870,363, filed on Jan. 23, 2023, now Pat. No. D1082052.

(51) Int. Cl. E06C 7/16; E06C 1/39

(52) U.S. Cl. CPC E06C 7/16; E06C 1/39

(57) ABSTRACT

The present invention relates to an extended platform apparatus for ladders, designed to enhance user comfort and safety during ladder use. The apparatus comprises a top rung cover, a bottom rung cover, a pair of side rails, and a platform. The top and bottom rung covers are configured to removably attach to the rungs of a standard ladder, forming a stable mounting structure. The side rails connect the top and bottom rung covers, providing structural rigidity and resistance to rotational forces. A platform is affixed to the bottom rung cover, offering a large, flat surface for a user to stand on, thereby reducing fatigue and improving stability. The invention further includes traction-enhancing surfaces and a safety system comprising locking pins to secure the apparatus to the ladder. The device is adaptable to various ladder sizes and may be constructed from aluminum, plastic, or composite materials.

### FIELD OF THE INVENTION

The present invention relates generally to ladders. More specifically, the present invention relates to platforms for ladders that help better support a user's foot.

### BACKGROUND OF THE INVENTION

The modern extension ladder typically has a rung that is only 2″ wide, while modern A-frame ladders typically have a 4″ wide rung. These small rung sizes enable modern ladders to be lightweight yet sturdy.

While these small rung sizes are helpful for keeping ladders lightweight and easy to transport, they do not properly support a user's foot. The user is required to stand on a thin rung with only a very small portion of their foot supported. Some people utilize ladders often in their occupations and stand on these thin rungs for long lengths. Over time the use of modern ladders leads to fatigue, wear, and tear on the user's feet along with their knees, backs, and other major joints.

Therefore, there is a need for solution that better provides a large surface for the user to stand on, when working for long durations. The solution should be able to be easily moved and installed. Further, the solution should provide support for the user's entire foot.

### SUMMARY OF THE INVENTION

The present invention is an extended platform for use with a ladder. The present invention offers a large platform that can be easily installed and moved along the length of most standard sized ladders. The large platform supports the user's entire foot offering a comfortable location to stand, while helping to reduce fatigue and prevent wear and tear on the user.

The present invention slides over top of and rest on the standard rungs the ladder. Allowing the ladder to be utilized as a standard ladder, without interfering with a user's ability to climb up and down, while providing a platform at a desired position to stand on. The invention may be easily moved up and down the length of the ladder and easily to removed and transported.

### BRIEF DESCRIPTION OF THE DRAWINGS

FIG. 1 shows a front left prospective view of a preferred embodiment of the present invention.

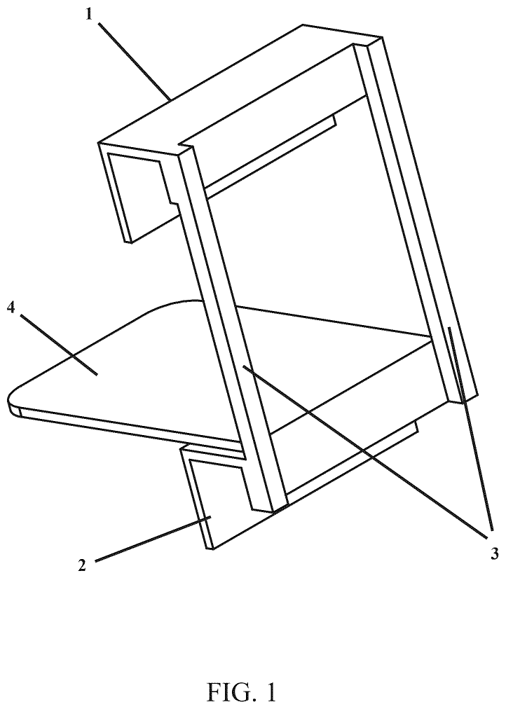

FIG. 2 shows a bottom right prospective view of a preferred embodiment of the present invention.

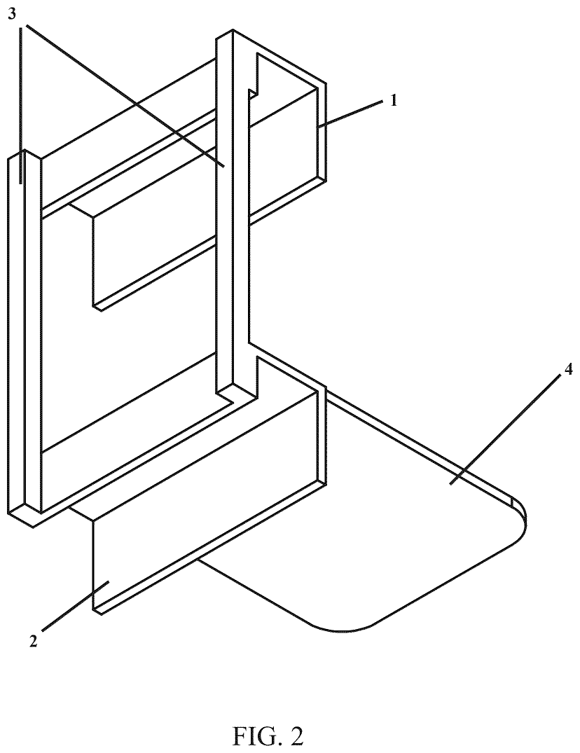

FIG. 3 shows a right elevation view of a preferred embodiment of the present invention.

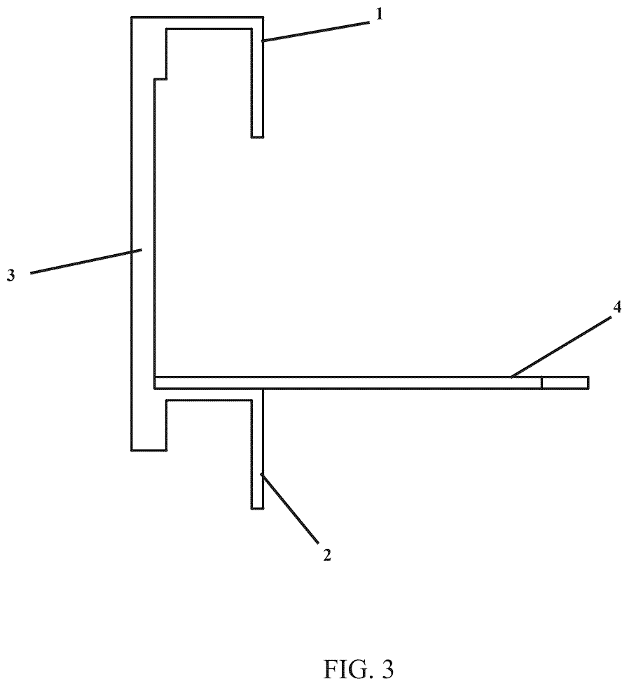

FIG. 4 shows a back elevation view of a preferred embodiment of the present invention.

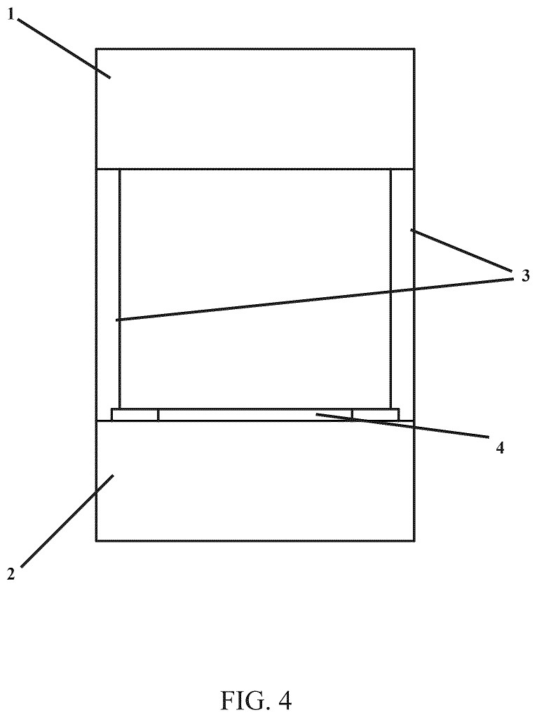

FIG. 5 shows a front elevation view of a preferred embodiment of the present invention.

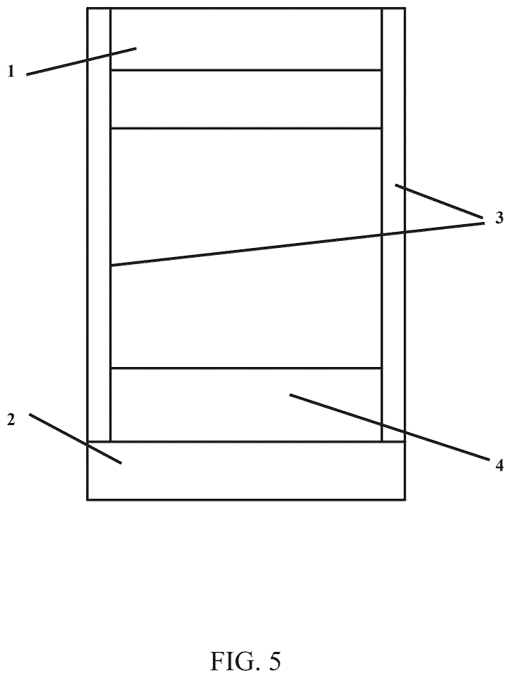

FIG. 6 shows a top plan view of a preferred embodiment of the present invention.

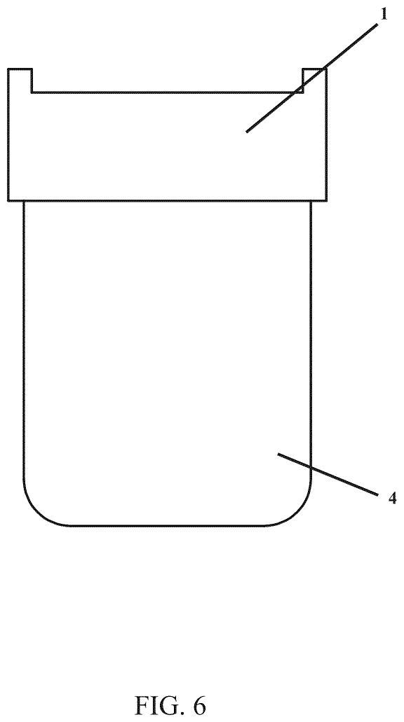

FIG. 7 shows a bottom plan view of a preferred embodiment of the present invention.

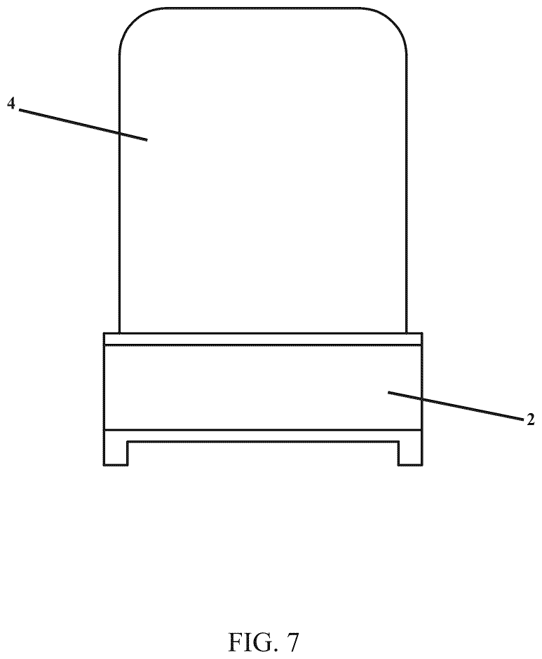

FIG. 8 shows a left front prospective view of a preferred embodiment of the present invention, installed on a ladder, the ladder being shown in dashed lines.

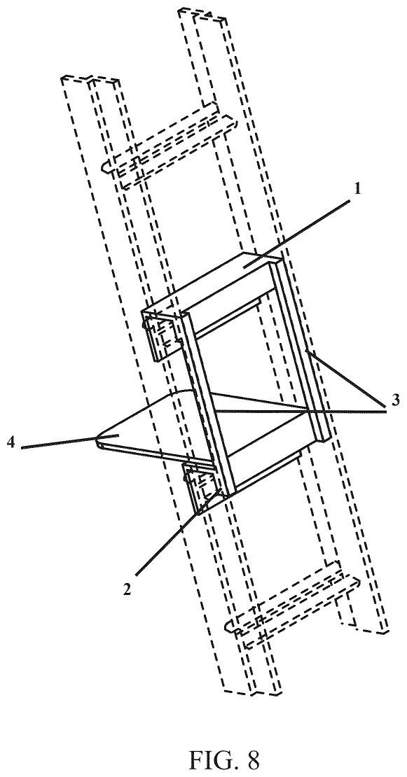

FIG. 9 shows a right elevation view of a preferred embodiment of the present invention installed on a ladder, the ladder being shown in dashed lines.

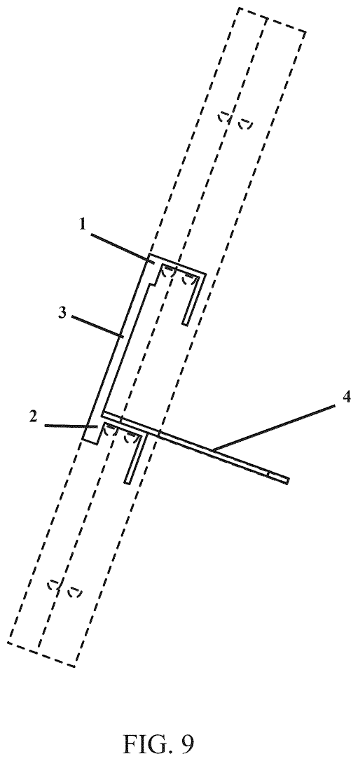

### DETAIL DESCRIPTIONS OF THE INVENTION

All illustrations of the drawings are for the purpose of describing selected versions of the present invention and are not intended to limit the scope of the present invention.

The present invention is an extended platform for use with a ladder. The present invention may be easily installed and moved on most standard sized ladders and offers a large platform (4) for a user to stand, helping to reduce fatigue and prevent wear and tear on the user. The present invention comprises a top rung cover (1), a bottom rung cover (2), a set of side rails (3), and a platform (4).

The top rung cover (1) of the present invention serves the function of sliding over and covering a single or two parallel rungs of a ladder. When the top rung cover (1) is installed over top of the rungs, the top rung cover (1) forms a removable or temporary attachment between the top rung cover (1) and the rungs of the ladder. In a preferred embodiment, the top rung cover (1) is shaped like a C-channel or box with a cavity or channel traversing the lower side. The cavity or channel of the top rung cover (1) being sized to fit over top of and rest on two rungs of a ladder. In a preferred embodiment, the top side of the top rung cover (1) is designed to be a flat surface with suitable traction to allow a user to comfortably stand upon. When the top rung cover (1) is installed over a rung or set of rungs, the top surface of the top rung cover (1) may be used by a user to step, climb, or stand upon similar to the rungs. In further embodiments, the top rung cover (1) may be sized and shaped to fit a ladder of any size or design.

In the preferred embodiment, the top rung cover (1) is constructed from aluminum. The aluminum shape may be created through any suitable means such as extrusion, welding, bending, or forming. Further embodiments may be constructed of any suitable material and created with any suitable means such as but not limited to molded plastics or formed composites.

The bottom rung cover (2) of the present invention serves the function of sliding over and covering a single or two parallel rungs of a ladder. When the bottom rung cover (2) is installed over top of the rungs, the bottom rung cover (2) forms a removable or temporary attachment between the top rung cover (1) and the rungs of the ladder. In a preferred embodiment, the top rung cover (1) is shaped similar to the top rung cover (1) being a C-channel or a box with a cavity or channel traversing the lower side. The cavity or channel of the bottom rung cover (2) being sized to fit over top of and rest on two rungs of a ladder. The top surface of the bottom rung cover (2) should be configured to receive the platform (4) of the present invention. In the preferred embodiment this top surface of the bottom rung cover (2) is a substantially flat surface. In further embodiments, the bottom rung cover (2) may be sized and shaped to fit a ladder of any size or design.

In the preferred embodiment, the bottom rung cover (2) is constructed from aluminum. The aluminum shape may be created through any suitable means such as extrusion, welding, bending, or forming. Further embodiments may be constructed of any suitable material and created with any suitable means such as but not limited to molded plastics or formed composites.

The set of side rails (3) of the present invention serves the function of connecting and providing a structure between the top rung cover (1) and the bottom rung cover (2). The connection between the top rung cover (1) and the bottom rung cover (2) creates a rigid system with two solid mounting points to a ladder. The two solid mounting points resisting any rotational forces applied by a user. Thereby, the present invention is able to be securely mounted or attached to a ladder and be securely held in position and orientation. In a preferred embodiment, the side rails (3) are shaped as a set of solid bars. One of the bars connecting one end of the top rung cover (1) and the bottom rung cover (2). The second bar connection the opposite ends of the top rung cover (1) and bottom rung cover (2). In further embodiments, the side rails (3) may be shaped or formed as need to provide connection and structure between the top rung cover (1) and the bottom rung cover (2). In the preferred embodiment, the side rails (3) are designed so when the present invention is installed, the side rails (3) fit within the ladder and do not extend outside of the sides of the ladder.

In a preferred embodiment, the side rails (3) are created from aluminum and connected to the top and bottom rung cover (2) through welding. In further embodiments, the side rails (3) may be constructed by any suitable material and connected through any suitable means including but not limited to molded plastics or formed composites.

The platform (4) of the present invention creates a large flat surface for the user to stand on. The large flat surface allowing a user to stand on and be supported by their entire foot. The use of the entire foot providing significant improvements in comfort and reducing fatigue, wear, and tear on a user. In a preferred embodiment, the platform (4) is a study flat surface roughly 12″ deep. The platform (4) being affixed or attached to the top surface of the bottom rung cover (2). In the preferred embodiment, the platform (4) is attached with the platform (4) being flush with edge of the bottom rung cover (2) adjacent the side rails (3) and extending over the opposite edge of the bottom rung. Thereby when installed on a ladder, the side rails (3) are adjacent to a user, and the platform (4) extends over top of the bottom rung cover (2) and inward away from the user. In further embodiments, the platform (4) may be positioned anywhere along the bottom rung cover (2). In some further embodiments, the platform (4) may be affixed or attached to the top rung cover (1) instead of the bottom rung cover (2).

In the preferred embodiment, the platform (4) is created from a portion of cut aluminum sheet or plate. The preferred embodiment being welded to the bottom rung cover (2). In further embodiments any suitable material may be used to create the platform (4) and any suitable means of forming or construction may be used such as but not limited to extrusion, molded plastics, or formed composites.

The preferred embodiment is further comprised of a section of traction material. The traction material adding a traction surface to the top rung cover (1), bottom rung cover (2), and the platform (4). In the preferred embodiment, the traction material is affixed through adhesives. In further embodiments any suitable traction material or method may be employed to increase the traction of any surface on the present invention. Such materials and methods include but are not limited to sanding, rolled textures, or other attached materials.

In the preferred embodiment, a majority of the components are created from aluminum using various means of creation. The present invention is not limited by material or construction. In further embodiments any suitable material may be used including but not limited to metals, plastics, or composites. Further any means of construction may be utilized including but not limited to cutting, stamping, molding, forming, or extruding. Further the components of the preferred embodiment are connected through welding. Further embodiments may utilize any form of attachment or connection including but not limited to fasteners, adhesives, molding, or forming.

The preferred embodiment is further comprised of a safety system. The safety system further comprises a set of safety pins. The top rung cover (1) may further comprise two sets of safety pin holes. In this preferred embodiment, after the present invention is attached or mounted to a ladder, a safety pin is inserted through one set of safety holes, the second safety pin inserted through a second set of safety holes. The safety pins close the over side of the C-channel of the rung cover, thereby ensuring the present invention can not be lifted off or removed from the ladder with the safety pins in place. Further embodiments of the system may include any number of systems for holding the present invention onto the ladder, such as but not limited to latches or straps.

Further embodiments of the present invention may be configured or sized to fit any type or design of ladder.

Although the invention has been explained in relation to its preferred embodiment, it is to be understood that many other possible modifications and variations can be made without departing from the spirit and scope of the invention.

What is claimed is:

1. An extended platform apparatus for use with a ladder, comprising:
a top rung cover configured to removably engage with at least one rung of the ladder;
a bottom rung cover configured to removably engage with at least one rung of the ladder;
a pair of side rails rigidly connecting the top rung cover to the bottom rung cover, such that the apparatus resists rotational movement when mounted on the ladder; and
a platform affixed to the bottom rung cover, the platform providing a flat surface for a user to stand upon;
wherein the top rung cover, bottom rung cover, and platform each include a traction-enhancing surface; and
wherein the apparatus further comprises a safety system including at least one safety pin configured to secure the top rung cover to the ladder.

2. The apparatus of claim 1, wherein the top rung cover and bottom rung cover each comprise a C-channel or box-shaped structure with a cavity sized to fit over two parallel rungs of the ladder.

3. The apparatus of claim 1, wherein the platform is approximately twelve inches deep and extends inward from the bottom rung cover when installed on the ladder.

4. The apparatus of claim 1, wherein the side rails are positioned within the width of the ladder and do not extend beyond the ladder's side rails.

5. The apparatus of claim 1, wherein the top rung cover, bottom rung cover, side rails, and platform are constructed from aluminum.

6. The apparatus of claim 1, wherein the traction-enhancing surface comprises an adhesive traction material.

7. The apparatus of claim 1, wherein the safety system comprises two safety pins inserted through corresponding holes in the top rung cover to prevent removal from the ladder.

8. The apparatus of claim 1, wherein the platform is welded to the bottom rung cover.

9. The apparatus of claim 1, wherein the apparatus is configured to be compatible with ladders of varying sizes and designs.

10. The apparatus of claim 1, wherein the platform is alternatively affixed to the top rung cover.
